(19) United States
(12) Patent Application Publication
(10) Pub. No.: US 2003/0034443 A1
(43) Pub. Date: Feb. 20, 2003

(54) Absolute humidity sensor to control drying equipment

(76) Inventors: Andrian I. Kouznetsov, Santa Barbara, CA (US); Anthony E. Jenkins, Stevensville, MI (US); Audrey Nelson, Goleta, CA (US); Rod J. Valenta, Santa Barbara, CA (US)

Correspondence Address: BAKER + HOSTETLER LLP, WASHINGTON SQUARE, SUITE 1100, 1050 CONNECTICUT AVE. N.W., WASHINGTON, DC, 20036-5304, US

(21) Appl. No.: 10/141,857

(22) Filed: May 10, 2002

Related U.S. Application Data
(63) Continuation-in-part of application No. 09/760,330, filed on Jan. 12, 2001.
(60) Provisional application No. 60/289,789, filed on May 10, 2001.

(51) Int. Cl. G01V 8/00

(52) U.S. Cl. 250/222.2

(57) ABSTRACT

A method for determining a drying cycle includes the steps of measuring absolute humidity within a drying apparatus before the drying apparatus starts a drying cycle and determining a baseline absolute humidity from the measured absolute humidity. Drift is compensated for using the baseline absolute humidity and the absolute humidity is measured within the drying apparatus after the drying apparatus starts the drying cycle. The end of the drying cycle is determined using the measured absolute humidity.

### PRIORITY

This application claims the benefit of U.S. Provisional Application No. 60/289,789 filed on May 10, 2001 and is a continuation-in-part of application Ser. No. 09/760,330 filed on Jan. 12, 2001. The above-identified applications are herein incorporated by reference.

### FIELD OF THE INVENTION

The present invention relates to sensing devices. More particularly, the invention relates to sensing devices used to control drying equipment.

### BACKGROUND OF THE INVENTION

Drying equipment, such as clothes dryers usually have a set of control parameters which can be set to dry items such as clothes, dishes, wood, etc. Control parameters such as: (1) temperature of the air inside the drying chamber, (2) air flow rate, and (3) duration of the drying cycle can be used to determine how long it will take to dry items such as clothes. The air temperature and air flow rate can be selected from a set of pre-determined values, whereas the duration of the drying cycle can be controlled by setting a timer. In these types of devices, where air temperature, air flow rate, and duration of the drying cycle must be selected from pre-determined parameters, the drying time must be estimated. This can be very inefficient, especially with an inexperienced users, resulting in a waste of energy and time.

Accordingly, a dryer that can accurately dry items within a dryer by sensing the items are dry is desired. This will result in energy savings, time savings and more convenient use of dryers.

### SUMMARY OF THE INVENTION

It is therefore a feature and advantage of the present invention to provide a sensor that can detect when items within a dryer are dry. The dryer is automatically turned off when the sensor has indicated that the items in the dryer are dry. This will result in savings in energy and time, and will add convenience.

It is another feature and advantage of the present invention to provide an accurate and durable sensor to provide a more accurate drying cycle control.

The above and other features and advantages are achieved through the use of a novel method for determining a drying cycle as herein disclosed. In accordance with one embodiment of the invention, the method for determining a drying cycle has the steps of measuring absolute humidity within a drying apparatus before the drying apparatus starts a drying cycle. A baseline absolute humidity is determined from the measured absolute humidity drift. Drift is then compensated for using the baseline absolute humidity. Absolute humidity is again measured within the drying apparatus after the drying apparatus starts the drying cycle. The end of the drying cycle is determined using the measured absolute humidity.

In accordance with another embodiment of the present invention, a device that determines a drying cycle has an absolute humidity sensor that measure absolute humidity within a drying apparatus before and after the drying apparatus starts a drying cycle. A baseline absolute humidity determiner in communication with the absolute humidity sensor determines a baseline absolute humidity from the measured absolute humidity. A drift compensator is in communication with the baseline humidity determinator and compensates for drift using the baseline absolute humidity. An end of cycle determiner determines the end of the drying cycle using the measured absolute humidity and is in communication with the absolute humidity sensor.

In accordance with another embodiment of the invention a system for determining a drying cycle includes an absolute humidity measuring means for measuring absolute humidity within a drying apparatus before and after the drying apparatus starts a drying cycle, and a baseline absolute humidity determining means for determining a baseline absolute humidity from the measured absolute humidity. A drift compensating means is provided for compensating for drift using the baseline absolute humidity, and an end of cycle determining means is provided for determining the end of the drying cycle using the measured absolute humidity.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is an illustration of an infrared (IR) absorption absolute humidity sensor.

FIG. 2 is a flow diagram showing the method steps of the present invention.

FIG. 3 is a graph of an absolute humidity profile.

### DETAILED DESCRIPTION OF THE INVENTION

This invention provides an absolute humidity sensor which can detect when items within a dryer are dry.

In one embodiment of the invention, a drying cycle control system includes an infrared absorption sensor that measures water molecules (absolute humidity) in the air. This measurement is used to determine when the contents of the dryer have reached a defined dryness. Other types of absolute humidity sensors could be used in other embodiments of the invention.

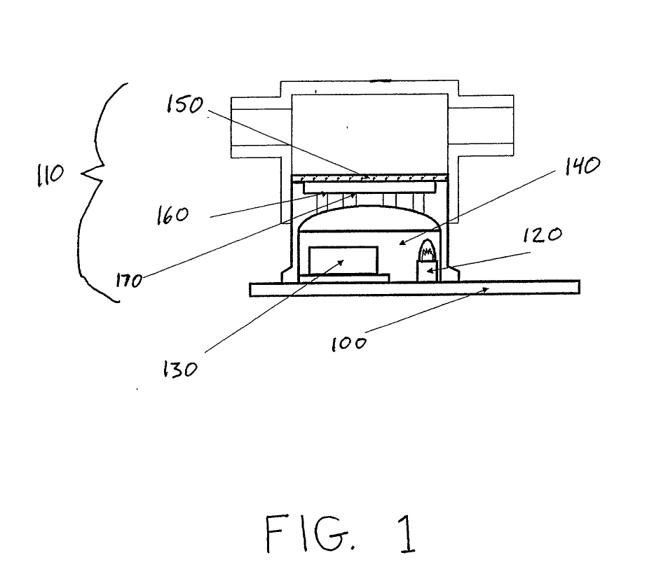

FIG. 1 illustrates an infrared (IR) absorption absolute humidity sensor of the present invention. In one embodiment of the invention, the absolute humidity sensor, can be located in the drying chamber exhaust. However, the sensor could also be located inside the drying chamber or in a special sampling system. The special sampling system could be arranged to deliver air from the chamber to the sensors. In any configuration, special care should be taken to prevent water condensation on the sensor or its electronics. This can be achieved by placing the sensor in a location where the temperature will be above the Dew Point level. In a preferred embodiment of the invention an IR absorption absolute humidity sensor is used. The IR absorption absolute humidity sensor as illustrated in FIG. 1 has a base 100, a diffuser 110, an infrared source 120, an infrared detector 130, and a detection chamber 140. The base can be a printed circuit board (PCB) to which the source 120, detector 130, and other electronics are mounted. The diffuser 110 is located between a gas flow path and detection chamber 140. This will prevent the exposure of sensitive sensor components to the full force and flow of gas. In this embodiment of the invention the gas is allowed to diffuse into a plastic reflective detection chamber 140. The diffuser 110 has a filter 150, which can be an oil, dust and moisture filter, an air gap 160, and a plurality of diffusion holes 170. The filter 150 is further operable to remove harmful materials, such as VOCs, dust particles, lint or moisture from the sample prior to measurement. The source 120 and detector 130 are located within the detection chamber 140. Detection chamber 5 can be coated with a material known to reflect infrared radiation, such as gold, in order to facilitate detection.

The gas sensor as illustrated in FIG. 1 operates under the principal of infrared absorption. This principal states that a gas will proportionately absorb infrared radiation or other radiant energy having particular characteristics, such as a particular wavelength or range of wavelengths. Thus, the amount of a particular gas component is proportional to the difference between the amount of source radiation and the amount of detected radiation. In one embodiment of the invention, a measurement can be made by exposing the gas sample to infrared energy having the appropriate characteristics for the gas component of interest, and measuring the amount of unabsorbed radiation. The measurement can be compared to a predetermined reference value established under known conditions. For example, the reference value can be established when there is an absence of the gas of interest.

In one embodiment of the invention, the detector of the IR radiation is a Perkin-Elmer® thermopile detector from the TPS535 family microns. The source is an incandescent miniature IR lamp (the 4115 lamp of Gilway®.) The optical distance between the source and the detector is about one inch. The IR source is pulsed with a frequency of about 1 Hz and a duty cycle of about 50%. Pulsing of the IR source makes the measurements of unabsorbed energy more accurate compared to continuous operation of the IR sensor.

The IR source 120 and the IR detector 130 are connected to sensor electronics on PCB 100. The sensor electronics control the source 120 and processes the signal from the detector 130. The result of the signal processing is the absolute humidity value of the sample. This value could be either communicated to the main control unit, or could be further processed by the absolute humidity sensor electronics. Thus, the control algorithm could reside either in the sensor processing unit or elsewhere in the control system.

In another embodiment of the invention, the absolute humidity sensor is complemented by a temperature sensor. This will provide additional information for the control algorithm. In addition, in more expensive commercial and industrial equipment, a number of absolute humidity sensors and temperature sensors can be used.

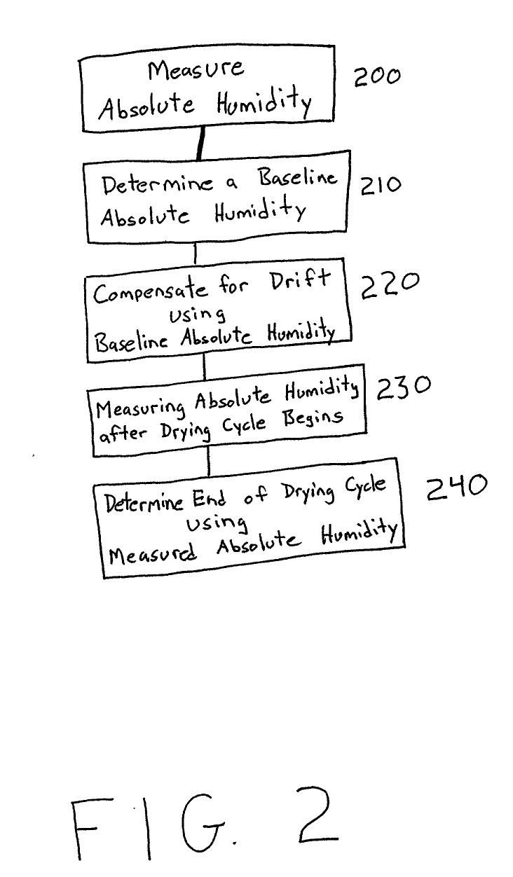

FIG. 2 illustrates the steps that are taken by the control system to determine an end of drying cycle. In step 200 the absolute humidity is measured before a drying cycle is initiated. Measured absolute humidity is used as a baseline for the control algorithm in step 210. In step 220 the ambient concentration is used as a baseline in order to determine long-term drift for the sensor. After the drying cycle starts, the sensor starts measuring the absolute humidity values for a given period in step 230. For example, a period of approximately one second can be used to provide an absolute humidity profile to the control algorithm. In step 240 the profile is used by the control algorithm to calculate the duration of the drying cycle. In addition, the control algorithm could also control the air intake rate and temperature. Once these measurements are taken, many different algorithms could be used to create an absolute humidity profile. The particular selection would depend on the specific dryer equipment as well as cost and performance requirements. A more complex algorithm normally requires more computational power, and thus increases the cost of the equipment, while providing better control.

In threshold-based algorithms, a threshold is established. The absolute humidity is then used to calculate how dry items in the dryer are. If this calculated value meets the threshold, the drying cycle will end. The first threshold algorithm is based on determining the ambient level of humidity before the drying cycle and finishing the drying cycle when the absolute humidity level in the drying chamber gets close to ambient, indicating that the clothes are dry. The threshold is calculated as:

Threshold=Ambient_Humidity*Dryness_Factor.

The dryness factor is always greater than 1 and can be set to reach a specific dryness.

The second threshold algorithm is based on the slope (rate of change) of absolute humidity. The algorithm continuously calculates the rate of change of the absolute humidity level. The dry cycle is terminated when the rate of change reaches a specific level. A more generic threshold based algorithm includes the continuous calculation of a set of parameters from the absolute humidity profile. The calculated parameters are used to define a time when the process should be stopped. One such parameter could be the rate of change, absolute humidity value, etc. The dry cycle can be terminated when a function of these parameters reaches a particular level Function(P1(t), P2(t), . . . PN(t))=Established_Level. The function could also be constructed as a linear combination of parameters P_{I}: Function=A₁*P1(t)=A₁*P1(t)+A₂*P2(t)+ . . . +A_{N}*Pn(t). More complex functions of parameters P_{I} can be constructed as well. The coefficients A₁ . . . Aₙ are characteristics of equipment and should be established during equipment testing. The established_level is user-controlled to set up a specific level of dryness.

In profile analysis-based algorithms, the profile is analyzed to predict the dry cycle time based on this analysis. Thus, the result of the analysis is a time required to dry items in the drying chamber.

The first profile analysis algorithm calculates the average humidity level for a specific fixed period of time and then uses this level to calculate the required dry time: dry_time=function (average humidity level, preset). The function could be a lookup table, a polynomial or any other easy to calculate function. Particular functions should be derived as characteristics of the particular drying equipment. The preset is the parameter that characterizes the required dryness.

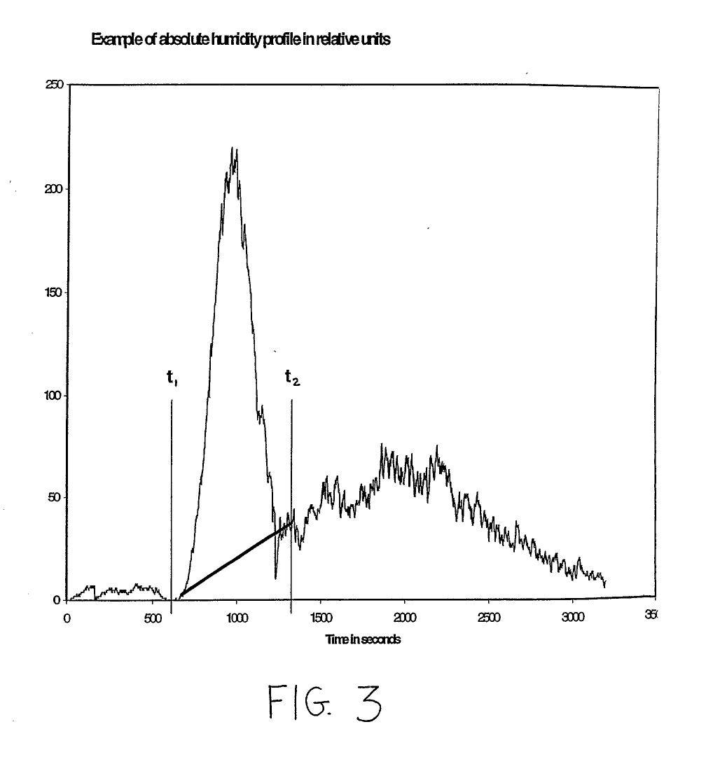

A variation of this algorithm does not use the average value, but the integral value—the area under the curve. The other variation of this algorithm would calculate the area under the curve as well, but the period of time for calculation would be variable, depending on a particular absolute humidity profile: Dry_time=function (integral_humidity (from T1 to T2)) where T1 is calculated as a moment of time when the absolute humidity reaches the particle threshold and T2 when the absolute humidity falls below the other threshold (see FIG. 3).

The second profile analysis algorithm uses maximum humidity level to calculate the time: Dry_time=function (max humidity level, preset).

The third profile analysis algorithm uses rate of change of humidity level at the beginning of the drying cycle: Dry_time=function (rate_of_change preset).

A more generic algorithm may include calculation parameters and establish dry times based on a function of these parameters and a preset dry_time=function (P1, P2, . . . P_{N}, preset). Some of the parameters may include not only absolute humidity data, but in addition, temperature data as well.

To further improve the accuracy of the control, the algorithm may used both threshold and analysis-based calculations. The expected dry time is calculated using the above equation. The dry cycle is then determined using this estimated time, along with a function, such as function (P₁(T), P₂(T), . . . P_{N}(T), estimated_time)=established_level. In most cases the function would be a linear combination of their arguments. Particular algorithm selection depends on the characteristics of the specific equipment, cost and required accuracy.

The many features and advantages of the invention are apparent from the detailed specification, and thus, it is intended by the appended claims to cover all such features and advantages of the invention which fall within the true spirit and scope of the invention. Further, since numerous modifications and variations will regularly occur to those skilled in the art, it is not desired to limit the invention to the exact instruction and operation illustrated and described, and accordingly, all suitable modifications and equivalents may be resorted to, falling within the scope of the invention.

The invention claimed is:

1. A method for determining a drying cycle comprising the steps of:
measuring absolute humidity within a drying apparatus before said drying apparatus starts a drying cycle;
determining a baseline absolute humidity from said measured absolute humidity;
compensating for drift using said baseline absolute humidity;
measuring absolute humidity within said drying apparatus after said drying apparatus starts said drying cycle; and
determining the end of said drying cycle using said measured absolute humidity.

2. The method as recited in claim 1 further comprising the step of controlling an air intake rate of said drying apparatus using said measured absolute humidity.

3. The method as recited in claim 1 further comprising the step of controlling temperature using said measured absolute humidity.

4. The method as recited in claim 1 further comprising the step of:
determining an ambient level of humidity before said drying cycle starts; and
wherein said step of determining the end of said drying cycle comprises the steps of:
setting a threshold according to said ambient level of humidity before said drying cycle starts; and
ending said drying cycle when said measured absolute humidity within said drying apparatus after said drying apparatus starts said drying cycle reaches said threshold.

5. The method as recited in claim 4, further comprising the step of calculating said threshold using the relationship:
Threshold=Ambient_Humidity*Dryness_Factor.

6. The method as recited in claim 1 further comprising the step of determining a rate of change in absolute humidity to determine the end of said drying cycle.

7. The method as recited in claim 1 further comprising the step of analyzing a profile to calculate a dry time to determine the end of said drying cycle.

8. The method as recited in claim 1 further comprising the step of calculating an average humidity level for a specific period of time to calculate a dry time to determine the end of said drying cycle.

9. The method as recited in claim 1 further comprising the step of calculating an integral value of absolute humidity for a specific period of time to calculate a dry time to determine the end of said drying cycle.

10. The method as recited in claim 1 further comprising the step of calculating a rate of change of absolute humidity for a specific period of time to calculate a dry time to determine the end of said drying cycle.

11. A device that determines a drying cycle comprising:
an absolute humidity sensor that measures absolute humidity within a drying apparatus before and after said drying apparatus starts a drying cycle;
a baseline absolute humidity determiner that determines a baseline absolute humidity from said measured absolute humidity, said baseline absolute humidity determiner in communication with said absolute humidity sensor;
a drift compensator that compensates for drift using said baseline absolute humidity, said drift compensator in communication with said baseline humidity determiner;
an end of cycle determiner that determines the end of said drying cycle using said measured absolute humidity and is in communication with said absolute humidity sensor.

12. The device as recited in claim 11 further comprising an air intake controller in communication with said end of cycle determiner, wherein said air intake controller controls air intake rate of said drying apparatus using said measured absolute humidity.

13. The device as recited in claim 11 further comprising a temperature controller in communication with said end of cycle determiner, wherein said temperature controller controls temperature using said measured absolute humidity.

14. The device as recited in claim 11 further comprising:
an ambient level of humidity determiner in communication with said end of cycle determiner, said ambient level of humidity determiner determining an ambient level of humidity before said drying cycle starts; and
wherein said end of cycle determiner comprises:
a threshold setter that sets a threshold according to said ambient level of humidity before said drying cycle starts; and
a determiner that determines an end of said drying cycle when said measured absolute humidity within said drying apparatus reaches said threshold.

15. The device as recited in claim 11 further comprising an analyzer in communication with said end of cycle determiner, said analyzer analyzing a profile to calculate a dry time to determine the end of said drying cycle.

16. A system for determining a drying cycle comprising:
an absolute humidity measuring means for measuring absolute humidity within a drying apparatus before and after said drying apparatus starts a drying cycle;
a baseline absolute humidity determining means for determining a baseline absolute humidity from said measured absolute humidity;
a drift compensating means for compensating for drift using said baseline absolute humidity; and
an end of cycle determining means for determining the end of said drying cycle using said measured absolute humidity.

17. The system as recited in claim 16 further comprising an air intake controlling means for controlling an air intake rate of said drying apparatus using said measured absolute humidity.

18. The system as recited in claim 16 further comprising a temperature controlling means for controlling temperature using said measured absolute humidity.

19. The system as recited in claim 16 further comprising:
an ambient humidity determining means for determining an ambient level of humidity before said drying cycle starts; and
wherein said end of cycle determining means comprises:
a threshold setting means for setting a threshold according to said ambient level of humidity before said drying cycle starts; and
an end of drying cycle means for ending said drying cycle when said measured absolute humidity within said drying apparatus after said drying apparatus starts said drying cycle reaches said threshold.

20. The system as recited in claim 16 further comprising an analyzing means for analyzing a profile using said measured absolute humidity to calculate a dry time to determine the end of said drying cycle.
